(19) United States
(12) Patent Application Publication
(10) Pub. No.: US 2012/0316831 A1
(43) Pub. Date: Dec. 13, 2012

(54) SYSTEM AND METHOD FOR DETERMINING ALTITUDE

(75) Inventor: Gunnar Klinghult, Lund (SE)

(73) Assignee: SONY ERICSSON MOBILE COMMUNICATIONS AB, Lund (SE)

(21) Appl. No.: 13/389,383

(22) PCT Filed: Feb. 18, 2011
(86) PCT No.: PCT/EP2011/052430

§ 371 Date: Feb. 7, 2012

(51) Int. Cl. G06F 15/00

(52) U.S. Cl. 702/166

(57) ABSTRACT

A method and system for altitude determination is provided. The altitude determination may be provided with the use of a dynamic mapping of altitude parameters and calculated altitudes for respective locations. The dynamic mapping may be provided by data received from users on a wireless network and/or public databases.

### TECHNICAL FIELD

Example embodiments presented herein relate to altitude calculations.

### BACKGROUND

Barometric sensors may be located in a number of devices. For example, such sensors may be located in mobile phones, navigational devices, Global Positioning System (GPS) based devices, or any form of multimedia or portable device. Barometric sensors may be used to provide an atmospheric pressure reading, which is the force per unit area exerted against a surface by the weight of air above that surface in the Earth's atmosphere. As elevation increases, so does the weight of atmospheric mass. Therefore, atmospheric pressure increases with increasing elevation. Thus, atmospheric pressure readings or measurements may be utilized in calculating the altitude of a location from which the reading is obtained.

### SUMMARY

One problem with altitude calculations using a barometric pressure sensor is that the measured ambient pressure may vary with the weather, the height above sea level, and the temperature. Measured pressure values may change quite quickly with harsh weather conditions, for example a thunderstorm. An accurately measured ambient pressure may be needed as a reference pressure in the calculation of the altitude.

Most barometric pressure sensors available today either assume that the reference pressure is a constant value without any adjustment or the sensor may be configured to let the user manually input a reference pressure value. Without correction or adjustment of the reference pressure, errors in the calculated altitude may be up to several hundreds of meters in some instances.

Thus, at least one object of the example embodiments presented herein may be to provide accurate reference pressure values, and therefore provide precise altitude calculations.

The example object may be achieved by a method for determining an altitude of a current location. The method may comprise sending or receiving a request for altitude determination from the current location, the request may comprise a two dimensional coordinate associated with the current location. For example, the two dimensional coordinate may be an X and Y coordinate position provided by a GPS location detection reading. In some example embodiments the X and Y coordinate may be a position measurement with respect to longitudinal and latitudinal positions. It should be appreciated that any other means for obtaining position information of a current location may be utilized.

If it is determined that the current location is not a high precision altitude location, the method may further comprise retrieving at least one altitude parameter associated with the current location from a dynamically compiled area mapping. In some example embodiments, a high precision altitude location may be a location for which an accurate altitude has been previously calculated or a location for which the altitude value is well known. For example, these locations may include points of interest such as bridges, points on roads or streets, building, and any other locations designated as reference points.

An area mapping may be a mapping of the at least one altitude parameter of a respective location. The at least one altitude parameter may comprise pressure, temperature, and/or altitude readings. Such readings may be provided via databases which may comprise altitude calculations of high precision locations, current temperatures, and/or pressure readings. The area mapping may also comprise at least one altitude parameter obtained from users on a sensor network. The users may comprise requesting devices or devices which have contacted the server for assistance in altitude determination.

The step of retrieving may be based on the two dimensional coordinate. Specifically, the at least one altitude parameter may be chosen based on the location of a requesting device, which may be provided by the two dimensional coordinate.

In some example embodiments, the computational unit may be located in an external server and the request for altitude determination may be received. The method may further comprise calculating the altitude determination as a function of the at least one altitude parameter. The method may also comprise the step of sending the calculated altitude determination to a requesting device.

In some example embodiments, the computational unit is located in a requesting device and the request for altitude determination may be sent. The step of retrieving may further comprise accessing an external server. The method may further comprise calculating the altitude determination as a function of the at least one altitude parameter. The method may further comprise sending the calculated altitude determination to the external server and providing an area mapping update indication. The area mapping update indication may be used to inform the external server that the area mapping may need to be updated with the newly calculated altitude.

If it is determined that the current location is a high precision altitude location, the area mapping may be used to obtain the altitude associated with the location, without the use of further calculations.

The method may further comprise the step of updating the dynamically compiled area mapping. The updating may comprise averaging and storing previously determined altitudes and/or altitude parameters from users on the wireless sensor network, the previously determined altitudes and/or altitude parameters may be associated with respective locations; and storing altitudes and/or altitude parameters from high precision altitude locations.

The method step of retrieving the at least one altitude parameter associated with the current location may further comprise determining the at least one altitude parameter based on time and/or range characteristics with respect to the current location. For example, the at least one altitude parameter may be chosen from the area mapping based on a predetermined range from the current location (i.e., altitude parameters within 10 meters of the current location may be acceptable for altitude calculations), and/or a predetermined time window (i.e., altitude parameters updated within 6 hours of the altitude determination request may be acceptable for altitude calculations).

The method may further comprise the step of assigning the current location as a high precision altitude location, this assignment may be performed as a function of at least one estimation threshold. The at least one estimation threshold may comprise a number of altitude estimations made with respect to the current location, time of a last estimation made in the current location, and/or a range of the last estimation made in surrounding location. Therefore, if a current location is a popular tourist destination in which multiple altitude determination requests are made, this location may be designated as a high precision altitude location. Thus, if many requests and altitude calculations are made with respect to a current location, the current location, as well as other locations within a predetermined range and time window, may be designated as high precision altitude locations.

Some example embodiments may be directed towards a computational unit. The computational unit may comprise an input interface that may be configured to send or receive a request for altitude determination from a current location, the request may comprise a two dimensional coordinate associated with the current location.

The computational unit may further comprise a processing unit that may be configured to retrieve at least one altitude parameter associated with the current location from a dynamically compiled area mapping if the current location is not a high precision altitude location. The mapping may be based in-part on a wireless sensor network. The retrieving may be performed as a function of the two dimensional coordinate.

The computational unit may be located in a server or navigational device. The computational unit may be further configured to perform any one of the method steps described above.

Some example embodiments may comprise a computer readable storage medium encoded with computer executable instructions, wherein the instructions, when executed by a computational unit, may perform any one of the method steps described above.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is an illustration of example devices which may comprise a computational unit according to some example embodiments;

FIG. 2 is a schematic of a computational unit according to some example embodiments;

FIG. 3 is a flow diagram depicting example operational steps of the computational unit of FIG. 2 according to some example embodiments; and

FIG. 4 is an illustrative working example for the purpose of exampling some of the example embodiments presented herein.

### DETAILED DESCRIPTION

In the following description, for purposes of explanation and not limitation, specific details are set forth, such as particular components, elements, techniques, etc. in order to provide a thorough understanding of the example embodiments. However, the example embodiments may be practiced in other manners that depart from these specific details. In other instances, detailed descriptions of well-known methods and elements are omitted so as not to obscure the description of the example embodiments.

Some example embodiments presented herein are directed towards the calculation of precise altitude measurements. According to some embodiments, precise altitude measurements may be obtained with the use of a computational unit.

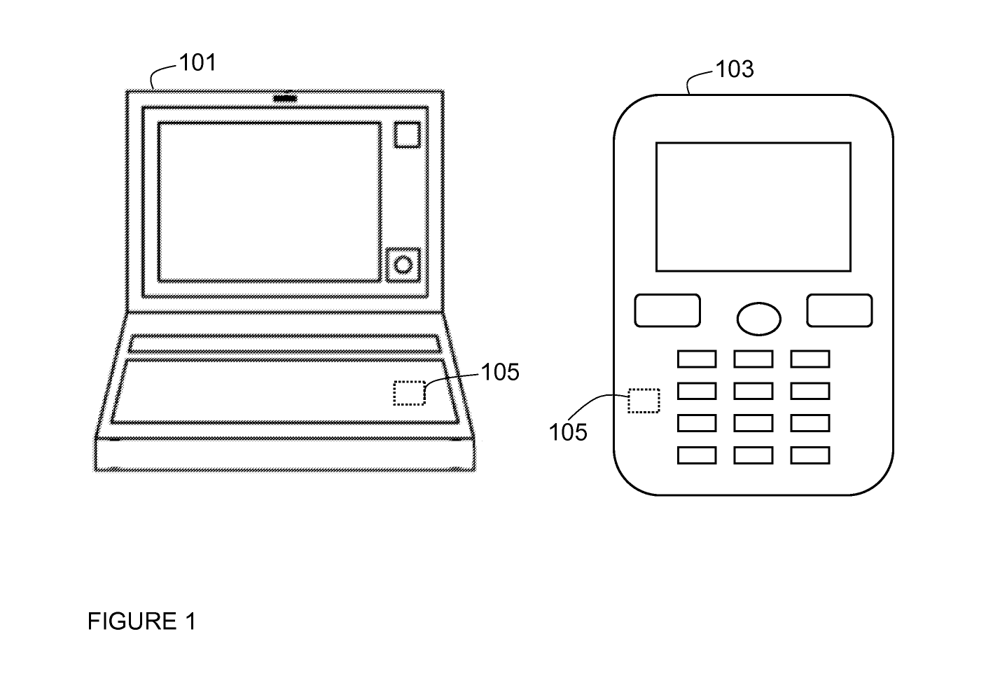

FIG. 1 provides an example of devices which may employ altitude determination according to the example embodiments presented herein. FIG. 1 depicts a laptop computer 101 and a mobile telephone 103. Both the computer 101 and telephone 103 comprise a computational unit 105. The devices 101 and 103 of FIG. 1 may be requesting devices, or devices which seek an altitude determination. It should be appreciated that while FIG. 1 only depicts a computer and mobile telephone, any other type of multimedia, tracking, navigational, or portable device may employ a computational unit 105. It should further be appreciated that the computational unit 105 may also be located in an external server (i.e., a server in communication with a wireless network composed of requesting devices). An external server may aid in the calculation of an altitude which may be based on information available on the wireless network.

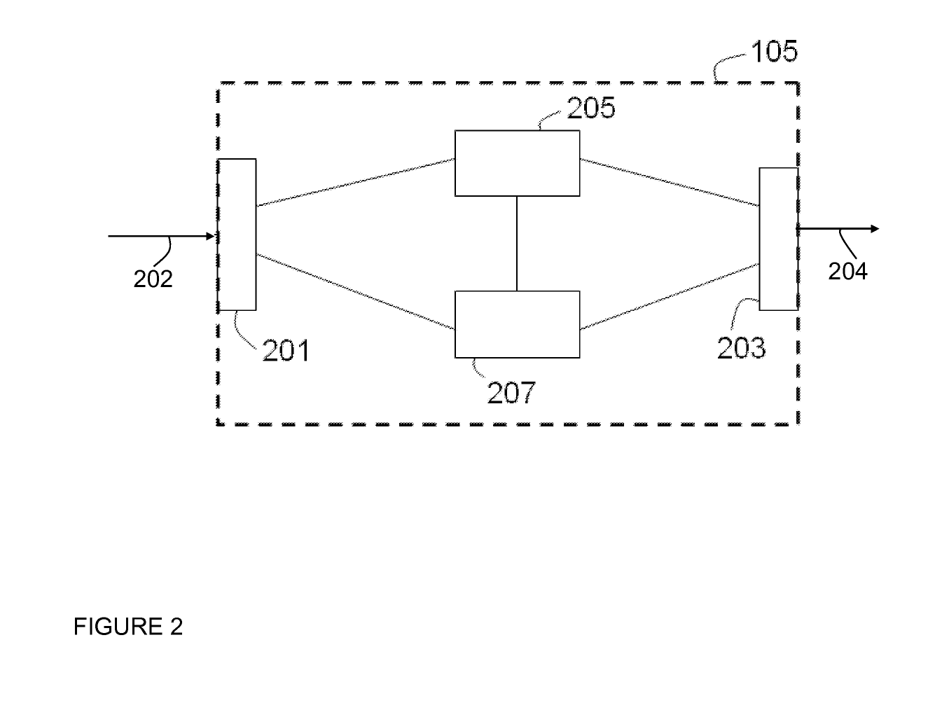

FIG. 2 is a schematic drawing of the computational unit 105 of FIG. 1. The computational unit 105 may comprise a receiver or input interface 201 and a transmitter or output interface 203, which may be able to transmit or receive any number or type of request signals 202 or altitude data 204. It should be appreciated that the computational unit 105 may alternatively comprise a single transceiver port. It should further be appreciated that the receiver, transmitter, or transceiver port may be in the form of any input/output communications port known in the art. It should also be appreciated that the receiver 201 and/or transmitter 203 may be in communication with at least one network or server. Alternatively, the computational unit 105 may also be located in a network or server. The computational unit 105 may send to and/or retrieve from the network or server 209, or other requesting devices, altitude determination data.

The computational unit 105 may further comprise a processing unit 207. The processing unit may be any suitable type of computation unit, e.g. a microprocessor, digital signal processor (DSP), field programmable gate array (FPGA), or application specific integrated circuit (ASIC). The processing unit 207 may be configured to determine an altitude for a current or requesting location. The determination of altitude may be provided by the following equation:

$$h = \frac{T}{{T}_{GRAD}} [ 1 - {( \frac{P}{{P}_{O}} )}^{{T}_{GRAD} \frac{R}{g}} ]$$

where h is the determined altitude, T is the ambient temperature at the current location, P is a pressure reading at the current location, P_{O} is a reference pressure at sea level, g is the constant value for gravity 9.82 m/s², T_{GRAD} is the temperature gradient, and R is the specific gas constant. It should be appreciated that an altitude may be provided through the use of any analysis or calculation known in the art.

The computational unit 105 may further comprise at least one memory unit 205 that may be in communication with the receiver 201 and/or transmitter 203. The memory unit 205 may be configured to store received, transmitted, and/or measured data and/or executable program instructions. The memory unit 205 may be further configured to store altitude determination parameters of the current or requesting device as well as nearby devices. The memory unit 205 may be any suitable type of computer readable memory and may be of volatile and/or non-volatile type.

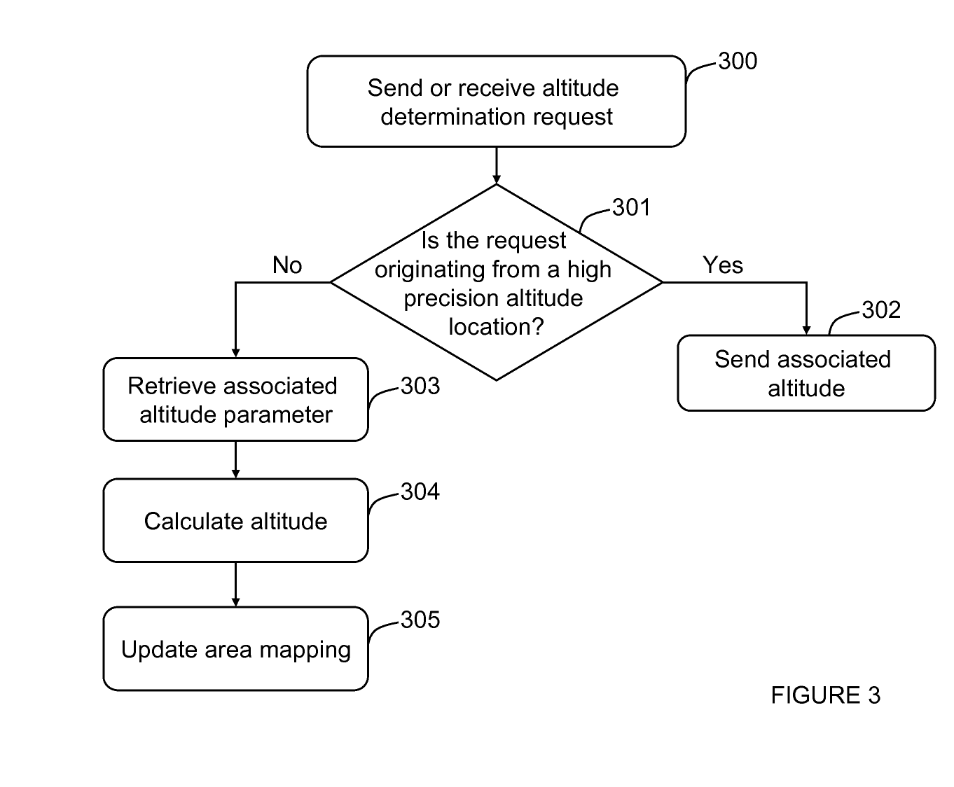

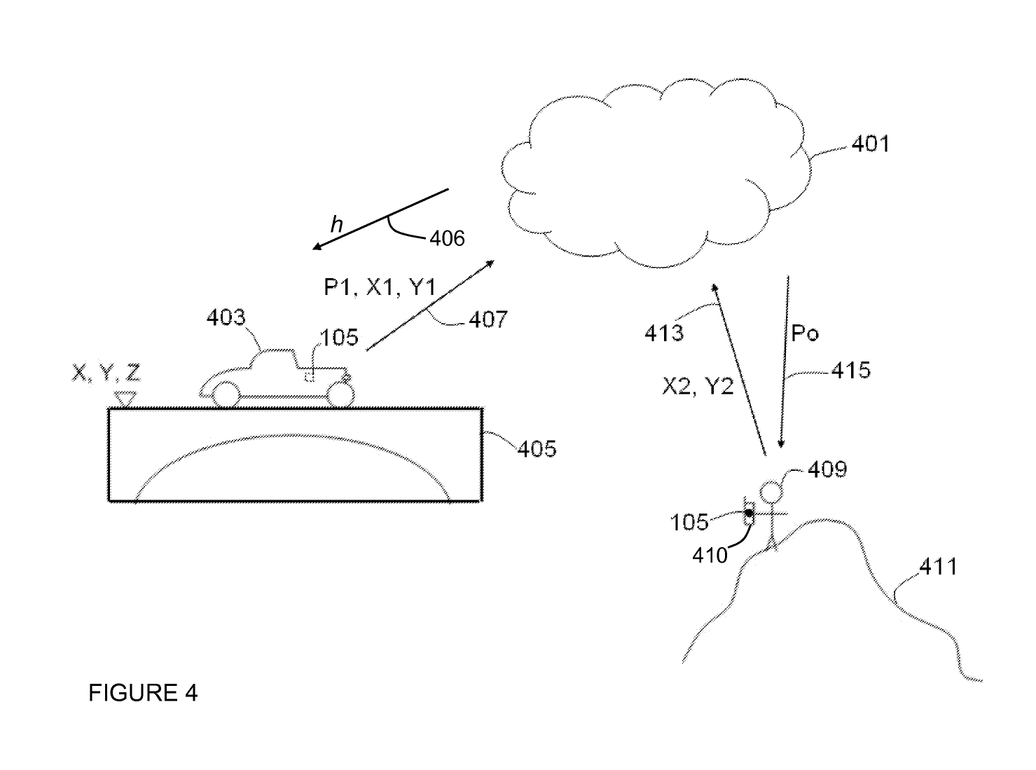

FIG. 3 is a flow diagram of example operational steps which may be taken by the computational unit of FIGS. 1 and 2. FIG. 4 is an illustrative example of how an altitude determination may be made. In the example provided by FIG. 4, an automobile (or requesting device) 403 may comprise a computational unit 105. The automobile 403 may be traveling on a bridge 405 and may send an altitude request signal 407 to an external server 401 (300). The request signal 407 may comprise a two dimensional coordinate (X1, Y1) indicative of a current location of the automobile 403. In some example embodiments, the X and Y coordinate may be a position measurement with respect to longitudinal and latitudinal positions. In the example provided by FIG. 4, the automobile 403 may comprise a GPS navigation device which may provide the two dimensional coordinate. The navigation device may also monitor and provide a measured reference pressure (P1). The reference pressure (P1) may also be sent to the external server 401 via the request signal 407. It should be appreciated that any other altitude determination parameters, that a user may have knowledge of, may be sent to the server 401.

Altitude determination parameters may be altitude parameters corresponding to respective locations. The altitude determination parameters may comprise temperature values (T) and/or pressure readings (P_{O}). The external server 401 may be in communication with a wireless network comprised of any number of requesting devices. The server 401 may comprise a mapping of altitude values or altitude determination parameters. The server 401 may obtain location specific altitudes and/or altitude determination parameters from a number of sources. For example, the server 401 may obtain the data from databases provided by public monitoring systems. Such public monitoring system may regularly and accurately maintain altitude values and/or altitude determination parameter values for locations of interest. An example of a public monitoring system may be the Geographic Information System (GIS). Locations of interest may be, for example, bridges, points on roads or streets, buildings, and/or reference points. The server 401 may also obtain data from requesting devices in the wireless network (e.g., device 403). The server 401 may also obtain data from users, or requesting devices, on a wireless network, which have contacted the server for assistance in altitude determination. It should be appreciated that the altitude mapping may be dynamically compiled or updated as the server 401 receives new altitude measurements and/or altitude parameters. In some example embodiments, a requesting device may send the external server 401 a mapping update indication thereby informing the server 401 that new data is available for updating the altitude mapping, thereby allowing the altitude mapping to be dynamically updated or compiled.

Upon receiving the request 407, the server 401 may make a determination as to whether or not the request is originating from a high precision altitude location (301). In some example embodiments, a high precision altitude location may be a location for which an accurate altitude has been previously calculated or a location for which the altitude value is well known. For example, a location in which an altitude is well known may be points of interest such as bridges, points on roads or streets, building, and any other locations designated as reference points.

In the example provided by FIG. 4, based on the transmitted position information (X1, Y1), the server 401 may be able to determine that the automobile 403 is in a high precision location position since the automobile is located in a point of interest (e.g., a bridge). Thus, the server 401 may be configured to send the automobile an altitude (h) 406 (302). Given that the automobile 403 is located in a high precision location (e.g., bridge 405); the altitude for the high precision location may already be stored in the mapping located in the server 401. Additionally, the server 401 may use any altitude determination parameter data sent in the request 407 (e.g., P_{O}) to further update the altitude mapping.

In some instances, the requesting device will not be situated in a high precision location. For example, a user 409 may send an altitude determination request 413 from a mobile device 410 include a computational unit 105 (300). The altitude determination request 413 may comprise a two dimensional coordinate (X2, Y2) indicative of the user's current location. It should be appreciated that the altitude determination request 413 may also include any other altitude determination parameters which the user or requesting device 410 has knowledge of.

Upon receipt of the request 413, the server 401 may make a determination as to whether or not the user 409 is in a high precision location (301). In the present example, the server 401 may make the determination that the user is not in a high precision location based on the received coordinate (X2, Y2). Thus, the server 401 may retrieve any altitude data associated with the received coordinate (X2, Y2) which may be saved in the altitude mapping (303).

The server may also be configured to retrieve data from surrounding areas based on time and/or range characteristic. For example, if a previously determined altitude or reference pressure associated with the received coordinate (X2, Y2) is not stored in the altitude mapping, the server 401 may be configured to retrieve a reference pressure from a known altitude in a surrounding area. Thus, the server 401 may be configured to select a surrounding area based on a range characteristic (e.g., locations within 50 meters may be selected) and/or a time characteristic (e.g., locations which have been updated within 4 days may be selected).

It should further be appreciated that the server 401 may be configured to determine altitude parameters based on calculated or known altitudes. For example, if a known or calculated altitude is available in a surrounding area, the server 401 may be configured to determine a reference pressure, P_{O}, by solving for the reference pressure using the equation described above.

Once the server 401 has retrieved an appropriate altitude parameter (e.g., P_{O}), the server may thereafter send a message 415 to the user and provide the retrieved altitude data. The requesting device 410 may in turn use the provided altitude parameter in calculating the altitude of the current location (304). The altitude may be calculated using the equation provided above. It should be appreciated that any other known methods for calculation altitude may be used. It should also be appreciated that the server 401 may be configured to perform the altitude calculation and send the calculated altitude to the user or requesting device.

Once the altitude for requesting device has been provided, the calculated altitude may be used to update the altitude mapping in the server 401 (305). Thus, should another request be made from the same location within an allowable time threshold (e.g., within 3 days of the previous calculation), the calculated altitude may be provided without the need of further calculation. It should be appreciated that if a location receives a large number of altitude determination requests, the location may be deemed as a high precision location. For example, a popular tourist destination may receive a large number of altitude determination requests. Therefore, designating the tourist location as a high precision location may reduce the amount of computational time needed to provide the necessary altitude data.

Some example embodiments may comprise a portable or non-portable telephone, media player, Personal Communications System (PCS) terminal, Personal Data Assistant (PDA), laptop computer, palmtop receiver, camera, television, radar and/or any appliance that comprises a transducer designed to transmit and/or receive radio, television, microwave, telephone and/or radar signals. The device according to the example embodiments is however intended for use particularly, but not exclusively for high frequency radio equipment.

The foregoing description of embodiments of the example embodiments, have been presented for purposes of illustration and description. The foregoing description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

A “device” as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) terminal that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc.

The various example embodiments described herein is described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1. A method for determining an altitude of a current location, the method comprising:
sending or receiving a request for altitude determination from the current location, the request comprising a two dimensional coordinate associated with the current location; and
if the current location is not a high precision altitude location, retrieving at least one altitude parameter associated with the current location from a dynamically compiled area mapping, said mapping being based in-part on a wireless sensor network, wherein the step of retrieving is performed as a function of the two dimensional coordinate.

2. The method of claim 1 wherein the request for altitude determination is received, the method further comprising:
calculating the altitude determination as a function of the at least one altitude parameter; and
sending the calculated altitude determination to a requesting device.

3. The method of claim 1 wherein the computational unit is located on an external server.

4. The method of claim 1 wherein the request for altitude determination is sent and the step of retrieving further comprises accessing an external server, the method further comprising:
calculating the altitude determination as a function of the at least one altitude parameter.

5. The method of claim 4 further comprising sending the calculated altitude determination to the external server and providing an area mapping update indication.

6. The method of claim 4 wherein the computational unit is located in a requesting device.

7. The method of claim 1 further comprising the step of updating the dynamically compiled area mapping, said updating comprising:
averaging and storing previously determined altitudes and/or altitude parameters from users on the wireless sensor network, the previously determined altitudes and/or altitude parameters being associated with respective locations; and
storing altitudes and/or altitude parameters from high precision altitude locations.

8. The method of claim 1 wherein the step of retrieving the at least one altitude parameter associated with the current location further comprises determining the at least one altitude parameter based on time and/or range characteristics with respect to the current location.

9. The method of claim 1 wherein the step of retrieving the at least one altitude parameter associated with the current location further comprises calculating the at least one altitude parameter by using a known or previously determined altitude.

10. The method of claim 1 wherein the at least one altitude parameter is a reference pressure, temperature, and/or altitude measurement.

11. The method of claim 1 further comprising the step of assigning the current location as a high precision altitude location as a function of at least one estimation threshold.

12. The method of claim 11 wherein the at least one estimation threshold comprises a number of altitude estimations made with respect to the current location, time of a last estimation made in the current location, and/or a range of the last estimation made in surrounding location.

13. A computational unit comprising:
a communication interface configured to send or receive a request for altitude determination from a current location, the request comprising a two dimensional coordinate associated with the current location; and
a processing unit configured to retrieve at least one altitude parameter associated with the current location from a dynamically compiled area mapping if the current location is not a high precision altitude location, said mapping being based in-part on a wireless sensor network, and wherein the retrieving is performed as a function of the two dimensional coordinate.

14. The computational unit of claim 13 wherein the processing unit is further configured to perform the steps of claim 2.

15. The computational unit according to claim 13 wherein the processing unit is configured to determine the at least one altitude parameter based on time and/or range characteristics with respect to the current location.

16. The computational unit of claim 13 wherein the processing unit is further configured to determine the at least one altitude parameter via a calculation using a known or previously determined altitude.

17. The computational unit according to claim 13 wherein the at least one altitude parameter is a reference pressure, temperature, and/or altitude measurement.

18. The computational unit according to claim 14 wherein the computational unit is located in a server or navigational device.

19. A computer readable storage medium encoded with computer executable instructions, wherein the instructions, when executed by a location beacon device, perform the method of claim 1.
